(19) United States
(12) Patent Application Publication
(10) Pub. No.: US 2025/0365262 A1
(43) Pub. Date: Nov. 27, 2025

(54) COMMUNICATIONS GATEWAY FOR PILOTS OF UNMANNED AIRCRAFT

(71) Applicant: SITA IT Services France S.A.S., Neuilly-sur-Seine (FR)

(72) Inventors: Olivier GUERIN, Neuilly-sur-Seine (FR); Florent BIRLING, Barcelona (ES); Nicolas VAN WAMBEKE, Neuilly-sur-Seine (FR); Damien GAUTHERIN, Neuilly-sur-Seine (FR)

(21) Appl. No.: 19/295,348

(22) Filed: Aug. 8, 2025

Related U.S. Application Data
(63) Continuation of application No. PCT/EP2024/055503, filed on Mar. 1, 2024.

(30) Foreign Application Priority Data
Mar. 3, 2023 (FR) 2302021

(51) Int. Cl. H04L 51/224; H04W 4/38; H04W 64/00; H04W 88/16

(52) U.S. Cl. CPC H04L 51/224; H04W 64/003; H04W 4/38; H04W 88/16

(57) ABSTRACT

An apparatus for communicating between remote pilots of unmanned aircraft and air traffic controllers is disclosed. The apparatus includes a gateway having a user management unit configured to receive a user message from a software application corresponding to a remote pilot, and authenticate the remote pilot based on the user message or the corresponding data connection; an application programming interface configured to generate an access token if the remote pilot is authenticated, and make a call to an API endpoint of an air traffic controller communications network; an emulator configured to parse the user message and to convert it into a compliant format; and a datalink connector configured to push the converted user message and the access token to the application programming interface endpoint. The datalink connector receives a message from the air traffic controller communications network and the user management unit communicates the message to the software application.

### CROSS-REFERENCE TO REPLATED APPLICATIONS

This application is a continuation of International Application No. PCT/EP2024/055503, filed on Mar. 1, 2024, and entitled “A COMMUNICATIONS GATEWAY FOR PILOTS OF UNMANNED AIRCRAFT,” which claims the benefit of and priority to French Patent Application No. 2302021, filed on Mar. 3, 2023, each of which are hereby incorporated by reference in their entireties as if set forth herein.

### TECHNICAL AREA

This application relates to an apparatus for providing communications between remote pilots of unmanned aircraft and air traffic controllers. In particular to a communications gateway that can be implemented in an efficient and scalable manner without requiring further avionics to be installed on the unmanned aircraft.

### BACKGROUND TO THE INVENTION

During piloted flight, pilots are required to make contact with Air Traffic Controllers (ATC) while they are operating in controlled airspaces, for example to request flight level authorisations or takeoff/landing clearance. These communications may be voice communications over radio spectrum (for example VHF or HF), voice communications over satellite communications (for example SATCOM), or digital communications over a datalink, for example using the controller-pilot data link communications (CPDLC) protocol.

Current trends are towards more and more complex and long distance missions being carried out between airports or vertiports by drones. Initially, this is most likely to be for logistics applications, but passenger transportation for Urban Air Mobility (UAM) is also anticipated in the near term. These drones may utilise electric Vehicle Take-Off and Landing (eVTOL) technologies and may be remotely controlled, or may be partially- or fully-autonomous. However, even fully autonomously flying drones will need to interact with ATC when operating in controlled airspace and it is envisaged that this would be carried out by a remote pilot overseeing one or more active flight missions. For example, a single remote pilot may supervise up to three active flights from the ground in one implementation.

For flight missions requiring ATC interaction, the drones may be equipped with VHF or HF radio systems for voice relay so that the remote pilot can communicate with ATC. In this manner, the drones have a VHF/HF communication channel open with the ATC in a similar manner to conventional piloted aircraft and it appears to the ATC as if the pilot is on the aircraft. However, the communications to and from the remote pilot are actually relayed between the drone that the remote pilot in a similar manner to the command and control (sometimes referred to as C2) communications that are used to manage and control the drone and its flight mission.

The inventors have appreciated that it would be desirable to enable ATC interactions with the remote pilot of a drone (which may be remote controlled, semi-autonomous, or fully-autonomous) in a more efficient and improved manner that is scalable, for example up to the scale of complex international operations.

### SUMMARY OF THE INVENTION

The invention is defined in the independent claims to which reference should now be directed. Advantageous features are set out in the dependent claims.

In a first aspect of the present disclosure, an apparatus for providing communications between remote pilots of unmanned aircraft and air traffic controllers is described. The apparatus comprises a gateway having: a user management unit configured to receive a user message from a software application corresponding to a remote pilot, and configured to authenticate the remote pilot based on the user message or the corresponding data connection; an application programming interface configured to generate an access token if the remote pilot is authenticated, and to make a call to an application programming interface endpoint of an air traffic controller communications network; a Controller Pilot Data Link Communications emulator configured to parse the user message and to convert it into a Controller Pilot Data Link Communications compliant format; and a datalink connector configured to push the converted user message and the access token to the application programming interface endpoint. The datalink connector is further configured to receive a message from the air traffic controller communications network and the user management unit is further configured to communicate the message to the software application.

In this manner, the apparatus of the first aspect of the present disclosure provides a gateway that opens up an alternative route for Controller Pilot Data Link Communications (CPDLC) messages to be sent between a remote pilot of an unmanned aircraft and the relevant ATC operator. This configuration is more efficient and more scalable that prior methods, while also reducing the amount of avionics equipment, in particular VHF communications equipment, that is required to be installed in the unmanned aircraft. By reducing the avionics payload, more weight can be used for goods/passengers, or a lower power consumption can be achieved.

Optionally, the apparatus may also comprise an aircraft management unit configured to receive unmanned aircraft data and to determine the air traffic controller network, of a plurality of air traffic controller networks, that the user message relates to, based on the unmanned aircraft data. This enables the apparatus to automatically determine the ATC network that is required to be communicated with for a given unmanned aircraft flight. Further, this may also be used to determine the appropriate endpoint of the ATC network.

Optionally, the unmanned aircraft data may comprise one or more of location data of the unmanned aircraft, flight plan data corresponding to the unmanned aircraft, and application programming interface call data. This data can then be used to determine which ATC or Air Navigation Service Provider (ANSP) is responsible for the airspace that the unmanned aircraft is due to take off from, due to fly through, or is flying through, or is due to land in. This can be used for routing the user message appropriately, and determining the correct endpoint for the API call.

Optionally, the aircraft management unit processes the unmanned aircraft data to verify whether the unmanned aircraft data corresponds to a valid state of a datalink state machine. The management unit manages the state machine within the ATC network and makes sure that all of the information exchanged with the ATC network is coherent with the ATC data standards.

Optionally, the aircraft management unit verifies the unmanned aircraft data by rules based validation of location data of the unmanned aircraft. In this manner, the apparatus can determine whether the data received from the unmanned aircraft is internally consistent, for example ensuring that the location data does not indicate that the aircraft is jumping between locations that it could not realistically fly to in the time since the last data point.

The user message may be a request to insert a data item into, or retrieve a data item from, the air traffic control communications network.

Optionally, the Controller Pilot Data Link Communications emulator is configured to convert the message received from the air traffic controller communications network into a format compliant with the remote pilot software application. This can enable the remote pilot software application to understand and process the complex CPDLC format messages received from the ATC network.

Optionally, the user management unit is configured to authenticate the remote pilot based on the use of a dedicated virtual private network channel or a private physical connection. This advantageously improves the security of the system and prevents unauthorised user access to the service. Users may need to be registered and pre-approved to use the service with appropriate strong security/authentication measures, such as password and one-time token protection.

Optionally, the remote pilot software application is a web application, and the gateway is configured to communicate with the web application. This advantageously improves the ease of implementation of the service.

Optionally, the apparatus is configured to connect to a web server of an aviation authority corresponding to the air traffic controller communications network, and to forward copies of all data passing through the gateway to the web server of the aviation authority.

Optionally, the datalink connector is configured to communicate with the application programming interface endpoint of the air traffic controller communications network via a ground network. This avoids the need for an air segment in the communication path, which greatly simplifies the system.

According to a second aspect of the present disclosure, there is provided a method for providing communications between remote pilots of unmanned aircraft and air traffic controllers, the method comprising: receiving, at a user management unit, a user message from a software application corresponding to a remote pilot; authenticating, at the user management unit, the remote pilot based on the user message or the corresponding data connection; generating, at an application programming interface, an access token if the remote pilot is authenticated; calling, by the application programming interface, an application programming interface endpoint of an air traffic controller communications network; parsing, by a Controller Pilot Data Link Communications emulator, the user message; converting, by the Controller Pilot Data Link Communications emulator, the user message into a Controller Pilot Data Link Communications compliant format; pushing, by a datalink connector, the converted user message and the access token to the application programming interface endpoint; receiving, at the datalink connector, a message from the air traffic controller communications network; and communicating, by the user management unit, the message to the software application.

In this manner, the method of the second aspect of the present disclosure provides a gateway that opens up an alternative route for Controller Pilot Data Link Communications (CPDLC) messages to be sent between a remote pilot of an unmanned aircraft and the relevant ATC operator. This configuration is more efficient and more scalable that prior methods, while also reducing the amount of avionics equipment, in particular VHF communications equipment, that is required to be installed in the unmanned aircraft. By reducing the avionics payload, more weight can be used for goods/passengers, or a lower power consumption can be achieved.

Optionally, the method further comprises receiving, by an aircraft management unit, unmanned aircraft data; and determining, by the aircraft management unit, the air traffic controller network, of a plurality of air traffic controller networks, that the user message relates to, based on the unmanned aircraft data. This enables the method to automatically determine the ATC network that is required to be communicated with for a given unmanned aircraft flight. Further, this may also be used to determine the appropriate endpoint of the ATC network.

Optionally, the unmanned aircraft data comprises one or more of location data of the unmanned aircraft, flight plan data corresponding to the unmanned aircraft, and application programming interface call data. This data can then be used to determine which ATC or Air Navigation Service Provider (ANSP) is responsible for the airspace that the unmanned aircraft is due to take off from, due to fly through, or is flying through, or is due to land in. This can be used for routing the user message appropriately, and determining the correct endpoint for the API call.

Optionally, the method further comprises processing, by the aircraft management unit, the unmanned aircraft data to verify whether the unmanned aircraft data corresponds to a valid state of a datalink state machine. Optionally, the unmanned aircraft data is verified by rules based validation of location data of the unmanned aircraft. In this manner, the method can determine whether the data received from the unmanned aircraft is internally consistent, for example ensuring that the location data does not indicate that the aircraft is jumping between locations that it could not realistically fly to in the time since the last data point.

Optionally, the user message is a request to insert a data item into, or retrieve a data item from, the air traffic control communications network.

Optionally, the method further comprises converting, by the Controller Pilot Data Link Communications emulator, the message received from the air traffic controller communications network into a format compliant with the remote pilot software application. This can enable the remote pilot software application to understand and process the complex CPDLC format messages received from the ATC network.

Optionally, the remote pilot is authenticated based on the use of a dedicated virtual private network channel or a private physical connection. This advantageously improves the security of the method and prevents unauthorised user access to the service. Users may need to be registered and pre-approved to use the service with appropriate strong security/authentication measures, such as password and one-time token protection.

Optionally, the remote pilot software application is a web application, and the gateway communicates with the web application. This advantageously improves the ease of implementation of the service.

Optionally, the method further comprises connecting to a web server of an aviation authority corresponding to the air traffic controller communications network, and forwarding copies of all data passing through the gateway to the web server of the aviation authority.

Optionally, the datalink connector communicates with the application programming interface endpoint of the air traffic controller communications network via a ground network. This avoids the need for an air segment in the communication path, which greatly simplifies the method.

### BRIEF DESCRIPTION OF THE DRAWINGS

Embodiments of the invention will now be described, by way of example only, and with reference to the accompanying drawings, in which:

FIG. 1 is an illustration of a system for communication between pilots and ATC controllers according to a first aspect of the present disclosure;

FIG. 2 is an example implementation of a gateway apparatus according to the first aspect of the present disclosure;

FIG. 3 is a diagram, illustrating the message flow methodology in the system of the present disclosure; and

FIG. 4 is a flowchart illustrating a method according to a second aspect of the present disclosure.

### DETAILED DESCRIPTION

Conventionally, aircraft pilots use voice messages or Controller Pilot Data Link Communications (CPDLC) to interact with Air Traffic Controllers (ATC) who are in charge of certain areas of controlled airspace. This communication may be required before departure, for example to request departure clearance, or during the flight, including requesting flight level changes, landing clearance, etc. These conventional communications between pilots and ATC may take place over VHF or HF radio communications or SATCOM communications. CPDLC messages are a way for the pilot to communicate with the ATC via text based messaging, and the set of messages are configured to correspond to the traditional voice phraseology employed by ATC procedures.

In this manner, the controller is provided with the capability to issue commands such as, level assignments, crossing constraints, lateral deviations, route changes and clearances, speed assignments, and radio frequency assignments, as well as various requests for information. In turn, the pilot is provided with the capability to respond to these messages, to request clearances, to request other information, to report information, and to declare/rescind an emergency notification.

For drone flights, remote pilots will be on the ground, but will still need a way to interact with ATC in the regions corresponding to the drone flight. This may require worldwide coverage, as the remote pilot would not need to be located in the same jurisdiction that the drone flight is operating in. Airspace across the world is split up into a number of three-dimensional (3D) blocks of space known as sectors. Each sector has one or more air traffic controllers that communicate with and are responsible for the safety of aircraft operating in, or about to enter, that airspace sector. These controllers work for Air Navigation Service Providers (ANSPs) and are trained to manage the aircraft such that there is a safe and orderly flow of aircraft from point to point in the most efficient manner.

Current solutions are based on voice practices by using voice relay over VHF whereby the remote pilots voice communications are sent to the drone/unmanned aircraft, and then relayed to ATC from the unmanned aircrafts onboard VHF radio. However, the present inventors have appreciated that these current solutions will not scale up to complex international operations, which will be required as Urban Air Mobility (UAM) and drone logistics become more prevalent in society.

In particular, the inventors have appreciated that the need for unmanned aircraft to have a VHF radio for use in ATC voice relay adds unnecessary weight to the vehicle, and these voice communications with a given ATC controller are carried out on the same frequency. This leads to a plurality of different pilots (remote or not) being tuned into the same frequency and as the number of flights air traffic controllers must handle increases with the increase in short flights expected with large drone and eVTOL services, the number of pilots tuned to a particular station will also be expected to increase. This increases the likelihood of errors and the amount of time it takes to process each request, which will lead to a saturation point wherein the controllers will not be able to handle any further aircraft.

The inventors have appreciated that these issues can be resolved if CPDLC is used with a new system of networks configured to enable ground based CPDLC, i.e. CPDLC communications that are not required to utilise an air based segment in the communication channel. This also removes the need for the unmanned aircraft to have convention VHF, HF, or SATCOM equipment onboard.

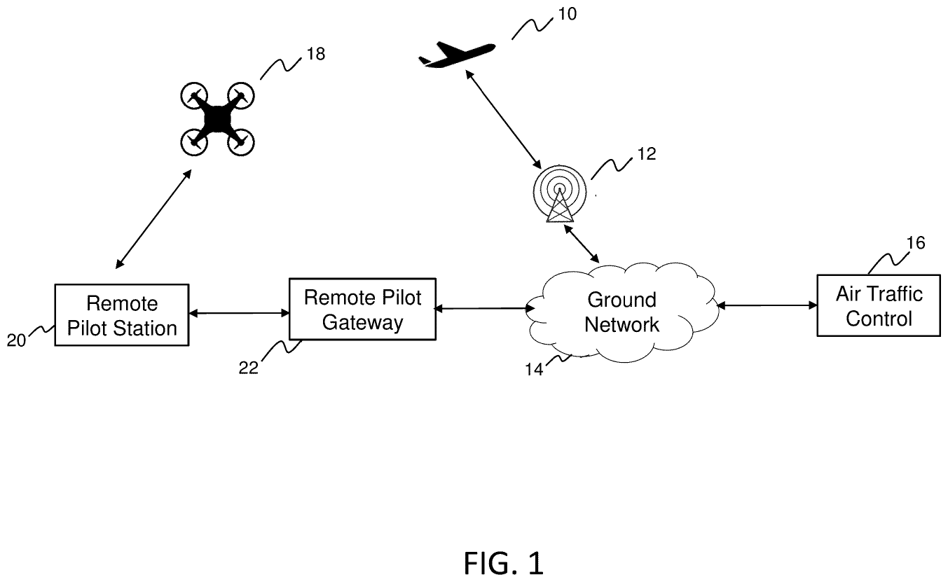

FIG. 1 is an illustration of a system for communication between pilots and ATC controllers. Conventionally, pilots in aircraft 10 talk to ATC controllers over VHF voice communications or CPDLC messages, which are received at a ground network 14 via one or more ground stations. The ground stations 12 may comprise VHF ground stations or HF ground stations that operate on the VHF or HF radio frequency ranges respectively. The term “ground station” is used herein to refer to any receiver station at ground level. For the avoidance of doubt, these ground stations may include receivers located on ocean platforms, such as oil rigs, or floating vessels, such as tankers or aircraft carriers. It will be appreciated that alternative communication routes between the aircraft 10 and the ground network 14 may alternatively be via a satellite link (not shown), in which case the ground station may be a satellite ground station. In either case, these pilot communications are then communicated to the ATC controllers 16 by a ground link.

There are two main implementations of conventional CPDLC systems. One is the Future Air Navigation System (FANS) data link system (FANS-1 or FANS-1/A), which is based on the aircraft communications addressing and reporting system (ACARS) in order to encapsulate messages between the ANSP and the aircraft. This is primarily used in oceanic routes with satellite communications by long haul aircraft. The other is the Aeronautical Telecommunication Network (ATN) CPDLC system, which is operational in many European Flight Information Regions (FIRs) with VHF Data Link (VDL) Mode 2 networks being used to support this service.

In the present disclosure, the aircraft are unmanned aircraft 18 that are remotely piloted, or supervised (in the case of semi- or fully-autonomous unmanned aircraft) by a pilot on the ground. The remote pilot logs into a Remote Pilot Station 20 that is configured with a command and control (C2) link to the unmanned aircraft 18. This C2 link may also be referred to as a Command and Control Non-Payload Communication (CNPC), and any communications means can be used for the C2/CNPC link, such as C-band or L-band radio communication links, which may be via satellite link in some examples.

In order for the remote pilot at the Remote Pilot Station 20 to communicate with the ATC controllers, the present disclosure provides a Remote Pilot Gateway 22 for interfacing the Remote Pilot Station 20 with the existing infrastructure of the Ground Network 14. This Remote Pilot Gateway provides a physical connection from the Remote Pilot Station 20 to the current Ground Network 14 through an unmanned aircraft to ATC controller that, in one embodiment, uses a high-level REST-like API to interface with any ATC controller station. The existing CPDLC protocols may be used for compatibility, but as noted above there will be no need for an air segment in the communication path from the pilot to the controller station at the ATC 16.

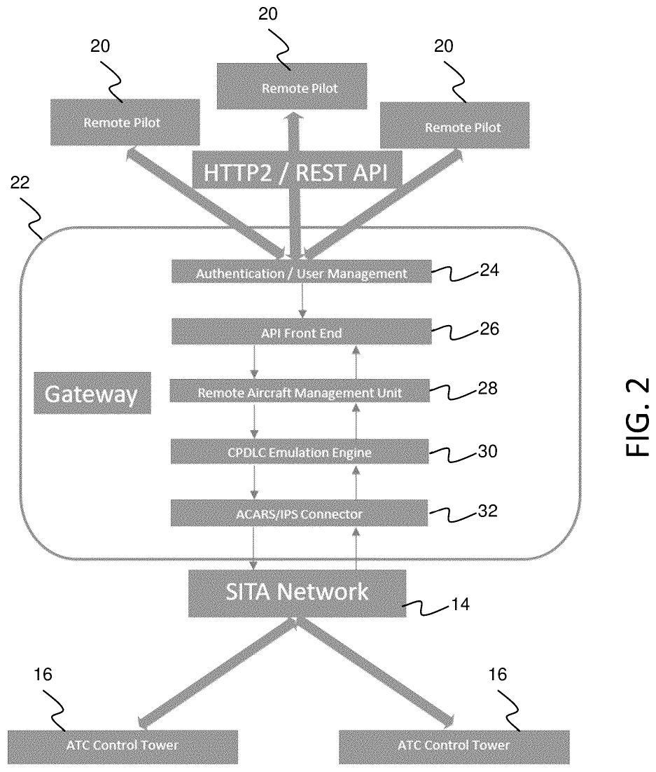

FIG. 2 is an example implementation of a Remote Pilot Gateway apparatus 22 according to the first aspect of the present disclosure. The Remote Pilot Gateway 22 is connects to the Remote Pilot Stations 22 over a connection, for example a web connection overt a REST API or HTTP2. As shown, the Remote Pilot Gateway apparatus may be connected to a plurality of Remote Pilot Stations 22. The Remote Pilot Gateway 22 comprises an authentication/user management unit or layer 24 that is configured to provide security to prevent unauthorized users accessing the gateway service. Each remote pilot user will sign up to the service, be pre-approved, and issues with login credentials, such as password protection and/or other rights protection. This may be implemented in any number of known ways as a by use of a dedicated VPN channel, the use of a private physical line or other strong security measures.

If user passes the user management authentication layer, an API front end layer 26 will generate an access token to be used in the communication with the endpoint in the network of the ATC controller 16 to authenticate the message from the Remote Pilot 20, for example a request to insert or retrieve a specific piece of data. In one example, the access token may be implemented using a standard HTTP authentication layer, such as an HTTP basic authentication, or any higher layer protocol (such as Open Authorisation/OAuth 2.0). The request is directed to a specific API end point and provides a simple way for the Remote Pilot 20 to interact with the system of Ground Network(s) 14 and Air Traffic Controllers 16 in any location across the world.

Once the end point has been correctly called, a remote aircraft management unit/layer can manage the communications to ensure that the unmanned aircraft is managed correctly.

For example, the remote aircraft management unit may process location data or flight plan data corresponding to the unmanned aircraft in order to determine the correct air traffic controller network for the remote pilot to be connected to, for example identifying the ATC responsible for the given region of airspace.

The remote aircraft management unit may also ensure that the unmanned aircraft data corresponds to a valid state of a datalink state machine. For example, context management may be used to process rules based verification of the location data. This may flag instances where the unmanned aircraft location report data appears to be jumping from one location to another where this would not be possible within the time since the last reported location data for the unmanned aircraft 18. An invalid datalink state could be reached, for example, if a remote pilot requested a flight level change before a logon request has been received and processed. The management unit may prevent such erroneous communications from being passed to the ATC network. In this manner, the management unit manages the state machine within the ATC network. The management unit also makes sure that all of the information exchanged with the ATC network is coherent with the ATC data standards.

A CPDLC emulation layer 30 may be configured to handle the complexity of context management, CPDLC and Automatic Dependent Surveillance Contract (ADS-C) message sets while exposing a simple interface through the API. Some examples of processing that may be required of the CPDLC emulation layer 30 include converting latitude and longitude into the complex format that is compliant with ADS-C, or standardising flight level clearance levels (for the unmanned aircraft to climb or descend to) that can be expressed in feet, or meter, or nivel.

ADS-C typically uses the FANS avionics systems that are a part of the on-board Flight Management Systems (FMS) of FANS equipped aircraft to automatically provide information such as the aircraft's position, altitude, speed, intent and meteorological data to users such as ANSPs or airlines. In the present case, it will be appreciate this this information could be reported from the Remote Pilot Station 20.

The outgoing messages with the right CPDLC syntax are then pushed or retrieved by an ACARS/IPS connector 32 to/from various existing datalink service provider networks 14 for forwarding to the individual ATC network endpoints 16. In this manner, legacy ACARS, ATN and IPS based ATC controller communication networks are supported. It will be appreciated that this communication channel is two-way and messages may also pass through the same processing in the gateway apparatus 22 from the ATC controller to the remote pilot logged into the Remote Pilot Station 20. In this case, the complex CPDLC communications will then be processed into a format that is compatible with the data format of the Remote Pilot Station 20.

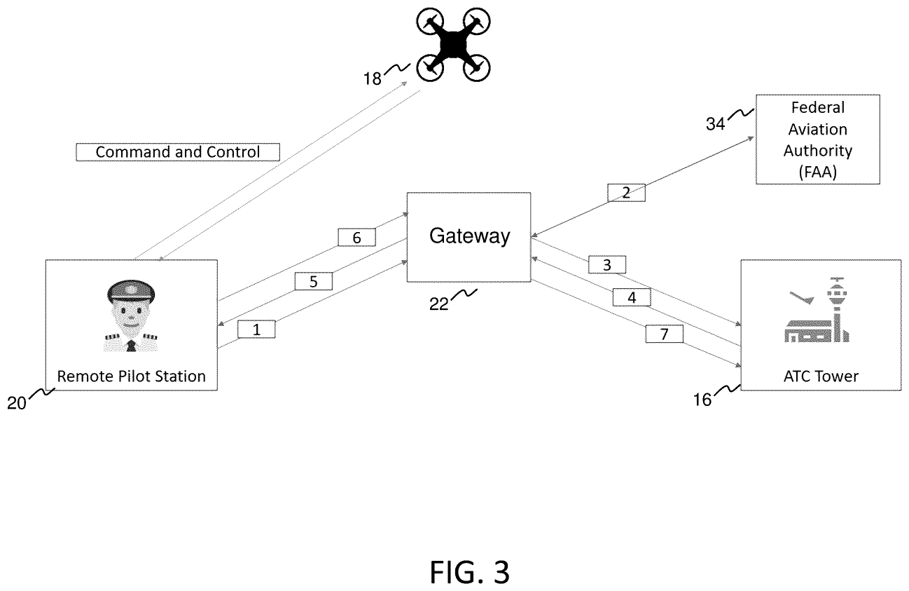

FIG. 3 is a diagram, illustrating the message flow methodology in the system of the present disclosure. In a first step, the remote pilot logs into their Remote Pilot Station 20 in order to initiate a flight. The remote pilot clicks on a button in their ATC communications web application to request departure clearance for the unmanned aircraft from the departure airport. This request may also include the flight plan/trajectory for the flight. The Remote Pilot Station 20 then sends this message to the gateway 22.

In step two, the Gateway 22 determines the appropriate ATC servers corresponding to the ATC controller responsible for the controlled airspace that the unmanned aircraft is due to take off from, and sends a copy of the data throughput to the servers of the aviation authority responsible for the jurisdiction of the intended unmanned aircraft flight. For example, this may include a context management logon request and other context management information, such as the Aircraft ID, the Control Centre ID, etc.

In step three, a CPDLC connection to the appropriate ATC servers and the departure clearance request is forwarded to the ATC controller. The ATC controller then enters a response, which is received by the Gateway 22 over the CPDLC connection, and this response is forwarded to the Gateway 22 at step four. The response is then processed and forwarded from the Gateway 22 to the Remote Pilot Station 20 of the remote pilot at step five. The remote pilot then enters a WILCO acknowledgement message into his web application and this acknowledgement is sent to the Gateway 22 at step six and then forwarded onto the ATC controller 16 at step seven.

It will be appreciated that further communications between the remote pilot and the ATC controllers may be exchanged in a similar manner throughout the rest of the unmanned aircraft operation.

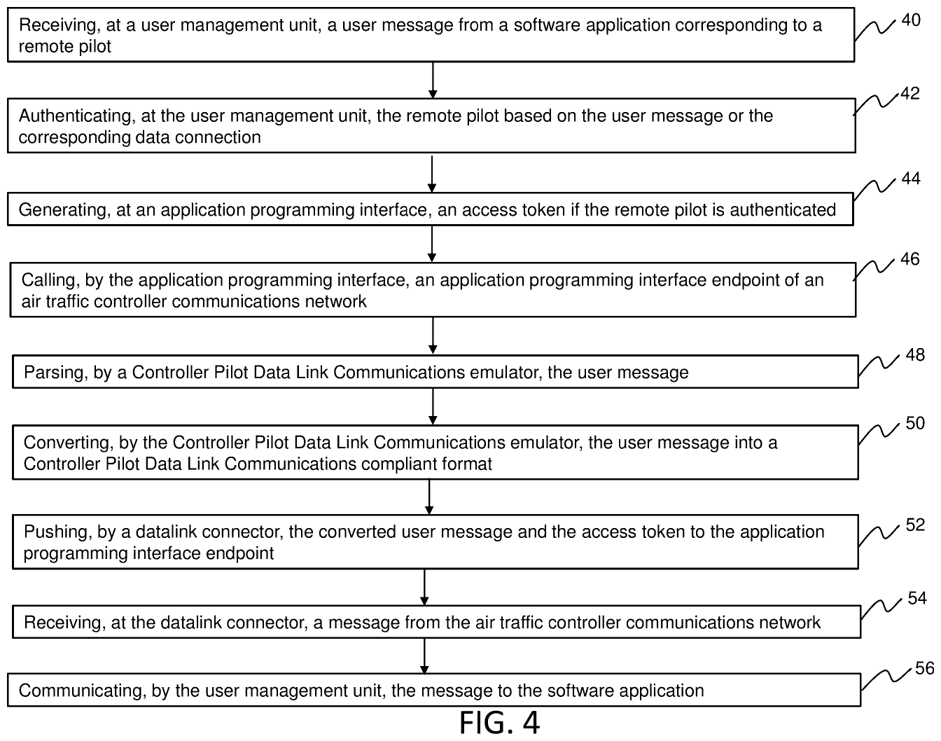

FIG. 4 is a flowchart illustrating a method according to a second aspect of the present disclosure for providing communications between remote pilots of unmanned aircraft and air traffic controllers. At step 40, the method comprises receiving, at a user management unit, a user message from a software application corresponding to a remote pilot. Then at step 42 the method comprises authenticating, at the user management unit, the remote pilot based on the user message or the corresponding data connection.

An application programming interface generates an access token at step 44 if the remote pilot is authenticated, and it then calls an application programming interface endpoint of an air traffic controller communications network at step 46. This creates a connection to the specific endpoint in the relevant ATC servers to be communicated with.

At step 48, the method comprises parsing, by a Controller Pilot Data Link Communications emulator, the user message and then the user message is converted at step 50 into a Controller Pilot Data Link Communications compliant format. At step 52, the converted user message and the access token are pushed by a datalink connector to the identified application programming interface endpoint.

Once the ATC controller has reviewed the user message from the remote pilot, they may prepare a response message and send this message from the air traffic controller communications network for receipt at the datalink connector at step 54. Finally, this message is then communicated, by the user management unit, the message to the software application of the remote pilot at step 56.

For completeness, it is noted that the flowchart of FIG. 4 illustrates the operation of an example implementation of a method according to the present disclosure. Each block in the flowchart may represent a module comprising one or more executable computer instructions, or a portion of an instruction, for implementing the relevant logical function specified in the block. Moreover, each block in the flowchart may be implemented in software, hardware or a combination of software and hardware.

As will be appreciated by the skilled person, the subject matter described herein may be embodied in whole or in part as a method, a system, or a computer program product including computer readable instructions. Accordingly, the subject matter of the present disclosure may take the form of an entirely hardware embodiment, an entirely software embodiment, or an embodiment combining software, firmware, hardware and/or any other suitable approach or apparatus.

Any computer readable program instructions may be stored on a non-transitory, tangible computer readable medium. The computer readable storage medium may include one or more of an electronic storage device, a magnetic storage device, an optical storage device, an electromagnetic storage device, a semiconductor storage device, a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk.

1. An apparatus for providing communications between remote pilots of unmanned aircraft and air traffic controllers, the apparatus comprising a gateway having a processor configured to:
receive a user message from a software application corresponding to a remote pilot, and configured to authenticate the remote pilot based on the user message or the corresponding data connection;
generate an access token if the remote pilot is authenticated, and to make a call to an application programming interface endpoint of an air traffic controller communications network;
parse the user message and to convert it into a Controller Pilot Data Link Communications compliant format; and
push the converted user message and the access token to the application programming interface endpoint of the air traffic controller communications network via a ground network;
wherein the gateway is further configured to receive a message from the air traffic controller communications network and the processor is further configured to communicate the message to the software application.

2. The apparatus of claim 1, wherein the processor is further configured to receive unmanned aircraft data and to determine the air traffic controller network, of a plurality of air traffic controller networks, that the user message relates to, based on the unmanned aircraft data.

3. The apparatus of claim 2, wherein the unmanned aircraft data comprises one or more of location data of the unmanned aircraft, flight plan data corresponding to the unmanned aircraft, and application programming interface call data.

4. The apparatus of claim 3, wherein the processor processes the unmanned aircraft data to verify whether the unmanned aircraft data corresponds to a valid state of a datalink state machine.

5. The apparatus of claim 4, wherein the processor verifies the unmanned aircraft data by rules based validation of location data of the unmanned aircraft.

6. The apparatus of claim 1, wherein the user message is a request to insert a data item into, or retrieve a data item from, the air traffic control communications network.

7. The apparatus of claim 1, wherein the processor is configured to convert the message received from the air traffic controller communications network into a format compliant with the remote pilot software application.

8. The apparatus of claim 1, wherein the processor is configured to authenticate the remote pilot based on the use of a dedicated virtual private network channel or a private physical connection.

9. The apparatus of claim 1, wherein the remote pilot software application is a web application, and the gateway is configured to communicate with the web application.

10. The apparatus of claim 1, wherein the apparatus is configured to connect to a web server of an aviation authority corresponding to the air traffic controller communications network, and to forward copies of all data passing through the gateway to the web server of the aviation authority.

11. A method for providing communications between remote pilots of unmanned aircraft and air traffic controllers, the method comprising:
receiving a user message from a software application corresponding to a remote pilot;
authenticating the remote pilot based on the user message or the corresponding data connection;
generating an access token if the remote pilot is authenticated;
calling an application programming interface endpoint of an air traffic controller communications network;
parsing the user message;
converting the user message into a Controller Pilot Data Link Communications compliant format;
pushing the converted user message and the access token to the application programming interface endpoint of the air traffic controller communications network via a ground network;
receiving a message from the air traffic controller communications network; and
communicating the message to the software application.

12. The method of claim 11, further comprising:
receiving unmanned aircraft data; and
determining the air traffic controller network, of a plurality of air traffic controller networks, that the user message relates to, based on the unmanned aircraft data.

13. The method of claim 12, wherein the unmanned aircraft data comprises one or more of location data of the unmanned aircraft, flight plan data corresponding to the unmanned aircraft, and application programming interface call data.

14. The method of claim 13, further comprising processing the unmanned aircraft data to verify whether the unmanned aircraft data corresponds to a valid state of a datalink state machine.

15. The method of claim 14, wherein the unmanned aircraft data is verified by rules based validation of location data of the unmanned aircraft.

16. The method of claim 11, wherein the user message is a request to insert a data item into, or retrieve a data item from, the air traffic control communications network.

17. The method of claim 11, further comprising converting the message received from the air traffic controller communications network into a format compliant with the remote pilot software application.

18. The method of claim 11, wherein the remote pilot is authenticated based on the use of a dedicated virtual private network channel or a private physical connection.

19. The method of claim 11, wherein the remote pilot software application is a web application, and the gateway communicates with the web application.

20. The method of claim 11, further comprising connecting to a web server of an aviation authority corresponding to the air traffic controller communications network, and forwarding copies of all data passing through the gateway to the web server of the aviation authority.
